(19) United States
(12) Patent Application Publication
(10) Pub. No.: US 2026/0225450 A1
(43) Pub. Date: Aug. 6, 2026

(54) System and Method for Discharging HVDC Capacitors

(71) Applicant: Garrett Transportation I Inc., Torrance, CA (US)

(72) Inventor: Raj Rana, Los Angeles, CA (US)

(73) Assignee: Garrett Transportation I Inc., Torrance, CA (US)

(21) Appl. No.: 19/044,652

(22) Filed: Feb. 4, 2025

(51) Int. Cl. B60L 3/00; H02M 1/32; H02M 7/797

(52) U.S. Cl. CPC B60L 3/003; H02M 1/322; H02M 7/797; B60L 2210/42

(57) ABSTRACT

A system and method for discharging a link capacitor is disclosed. A switched MOSFET operating in linear mode receives a control signal based upon a single leg. By way of example, the control signal generated by an operational amplifier in receipt of a first reference signal and a second signal indicative of the charge at the link capacitor to be discharged. The operational amplifier compares the first and second signal and based upon the comparison generates the control signal which connects the link capacitor discharge to a load resistor which works to dissipate the discharge thereby reducing the charge at the link capacitor, which, in turn, reduces the second signal, which, in turn, comes closer to the first reference signal. When the first and second signal are within a predetermined bandwidth, the operational amplifier signals the MOSFET to deactivate the connection between link capacitor and resistor.

### BACKGROUND OF THE INVENTION

### Field of the Invention

The present invention is directed to the field of vehicle electrical drive systems and the rapid discharge of capacitors within such systems as may be required during a vehicle shutdown.

### Description of Related Art

The global automotive industry is undergoing a transformative shift toward electrification, in the form of electric and/or hybrid electric vehicles (EV) as a response to growing environmental concerns and advancements in technology. As these technologies gain traction, their operational efficiency hinges on the effective management of energy, both during consumption as well as recovery. Central to this energy ecosystem is the automotive inverter; a device that plays a crucial role in bridging the gap between an electric vehicle's battery system and its motor. Automotive inverters are power electronic systems that convert direct current (DC) electricity stored in the EV high-voltage batteries into alternating current (AC) electricity needed by electric motors. Beyond mere energy conversion, inverters are responsible for regulating the motor's speed and torque and ensuring smooth vehicle operation under various driving conditions. They also facilitate regenerative braking, where energy is captured during deceleration and converted back into stored electricity, thereby enhancing overall efficiency.

Automotive inverters are composed of several key components. A first component is the power semiconductor device that is at the heart of the inverter and is responsible for switching electrical signals to produce the desired AC output. These devices include insulated gate bipolar transistors (IGBTs) that are commonly used in high-power applications, offering high efficiency and fast switching speeds. Metal-oxide-semiconductor field-effect transistors (MOSFETs) are present and preferred for lower power applications and high-frequency operation. As is known, a MOSFET is a type of transistor widely used in electronic circuits, especially in power electronics. It acts as a switch or amplifier, allowing for the control of large electrical currents with relatively small control voltages. In the context of an HVDC bus with an HVDC link capacitor, MOSFETs play a critical role in controlling and regulating the flow of electrical energy. A MOSFET is a three-terminal device: a source (S) where current exits the MOSFET, a drain (D) where current enters the MOSFET, and a gate (G) which acts as a control terminal that regulates the current flow between the source and drain. MOSFETs can be categorized into two main types: N-channel MOSFET being the most commonly used type, where current flows from the drain to the source when the gate voltage is sufficiently positive; and P-channel MOSFET where current flows from the source to the drain when the gate voltage is sufficiently negative. The MOSFET operates by creating an electric field when a voltage is applied to the gate terminal. This electric field modulates the conductivity of a semiconductor material between the source and drain, allowing current to flow or preventing its flow. The gate voltage effectively turns the MOSFET on (allowing current to pass) or off (blocking current flow). Accordingly, when the MOSFET is on (conducting) the source-drain path is at a very low resistance, allowing current to flow freely, and, when the MOSFET is off (non-conducting) the source-drain path has a high resistance, and as such little or no current flows. Additionally, devices include a control unit that is essentially the brain of the inverter and is configured to manage the switching of semiconductor devices to produce a desired AC waveform. It uses advanced algorithms like pulse width modulation (PWM) to adjust the voltage and frequency of the output. Further components include capacitors that are used to smooth out fluctuations in voltage and ensure stable operation, and resistors that are used to limit current inrush when an inverter powers up, safely dissipate energy as may arise during regenerative braking and absorb voltage spikes a may be caused by switching operations. Still further, such devices include a cooling system, housing and connectors. Inverters generate heat during operation, especially in high-power applications. A cooling system, often liquid-cooled or air-cooled, is essential to maintain optimal operating temperatures and prevent overheating. Lastly, the inverter is enclosed in a durable housing to protect it from environmental factors such as dust, moisture, and vibration. It also includes connectors for interfacing with the battery, motor, and vehicle control systems.

Different types of inverters are used in EVs, a common one being voltage source inverters (VSIs) that convert DC voltage into AC voltage using a capacitor as the energy storage element. VSIs are preferred for their simplicity and efficiency.

Safety is paramount in automotive applications, and the inverter incorporates several features to protect both the vehicle and its occupants. A first includes overcurrent and overvoltage protection. Here, the inverter monitors electrical parameters and shuts down power flow in the event of abnormal current or voltage levels, thereby preventing damage to the motor or battery. Another feature includes fault detection and diagnostics wherein integrated sensors and control algorithms enable the inverter to detect faults such as short circuits or component failures. These issues are communicated to the vehicle's control system for appropriate action such as vehicle shutdown and/or the rapid discharge of the inverter.

EV powertrains make use of high voltage direct current buses (HVDC Bus) as a central electrical distribution point where high-voltage direct current electricity is collected, distributed, or routed to different components. The HVDC Bus acts as a common node connecting key systems such as the battery, inverter, electric motor, and other power electronics. Key functions of the HVDC Bus include not only the central power distribution, but also voltage stabilization by helping to maintain a stable high voltage for efficient operation of the powertrain; energy flow management by facilitating bidirectional power flow from battery to motor during propulsion and from motor to the battery during regenerative braking; and component integration by providing a platform for connecting auxiliary systems like air conditioning, heating, or charging systems that rely on high-voltage electricity.

An HVDC link capacitor is an electrical component used in High Voltage Direct Current (HVDC) systems to improve performance, stability, and efficiency. It is typically placed within the HVDC link, which is the system connecting the two ends of an HVDC transmission network (e.g., between power stations or in vehicle powertrains). The HVDC link capacitor plays a crucial role in supporting the operation of the HVDC system by addressing certain key electrical challenges such as filtering, voltage regulation, and power factor correction. In essence, the HVDC link capacitor stores energy in the form of an electric field when there is an excess of voltage in the system. When there is a demand for additional power, it discharges the stored energy to maintain the voltage level and supply the necessary energy to the system. This storage and discharge mechanism helps ensure that the power delivered is consistent and that the system operates efficiently without excessive voltage fluctuations. Other types of capacitors in an HVDC system include DC Link Capacitors which are directly connected to the DC side of the HVDC link, between the rectifier and inverter. They store and release energy to stabilize the DC voltage across the link. Shunt Capacitors are often used in HVDC systems as reactive power compensators. They are connected in parallel with the system to supply or absorb reactive power, improving voltage control and system stability. Smoothing Capacitors may be applied in some HVDC systems, wherein large smoothing capacitors are placed on the DC link to reduce ripple voltage caused by rectification. These capacitors smooth out the variations in the DC voltage waveform to provide a more stable output. Filter Capacitors may be used in combination with inductors to form LC filters that remove high-frequency harmonics generated by the switching process in the converters. While the present invention will be described with respect to the HVDC link capacitor, application of the present invention to other such capacitors, as for example listed in the aforementioned, is included within the present invention's scope.

Within the context of an HVDC system, capacitors are typically placed in parallel with the DC link to maintain voltage stability and to store energy during high-load periods or regenerative braking in vehicles. MOSFETs work alongside capacitors to charge/discharge them as well as regulate voltage across them thus preventing the capacitor from exceeding its voltage rating and ensuring safe operation by controlling how much energy is stored. MOSFETs may also be used for energy transfer and power flow control, including in fault protection of capacitors in the event of a short circuit or voltage spike by disconnecting the capacitor from the circuit when an unsafe condition is detected. This prevents the capacitor from being damaged and ensures the overall system remains stable.

Safety requirements include rapid and safe HVDC capacitor discharge. Such requires careful consideration of safety protocols, equipment, and methods to avoid hazards such as electric shock, thermal damage, or harm to other components. The discharging process should be performed systematically, and the methods used must ensure that the capacitor's stored energy is safely dissipated. For automotive inverters, especially EVs, the HVDC bus is typically charged up to 800 V or more. As the automobile battery charges, so does the HVDC capacitor. In the event of a crash, emergency, fault condition and the like, the energy stored in the HVDC capacitor poses a severe safety risk including electric shock, damage to electronic components and/or fire hazards. It is known in the art that HVDC capacitors may be discharged using discharge circuits.

A known method makes use of bleeder resistors or discharge resistors, wherein the resistor is connected across the HVDC capacitor's terminals to gradually dissipate the stored energy as heat. The resistor value is typically chosen based on the capacitor's voltage and energy capacity. When the resistor is connected to the capacitor, it provides a path for the current to flow from the positive to the negative terminal of the capacitor, gradually discharging the capacitor over time. The time constant for discharging is determined by the formula \(\tau=R\times C\) , where \(tau\) is the time constant, \(R\) is the resistance, and \(C\) is the capacitance of the capacitor. The discharge process is usually electronically monitored, and once the voltage across the capacitor reaches a safe level, the resistor can be removed.

Examples of prior art systems for discharging DC link capacitors from United States Patent Application Publication US2017/0355267 (hereinafter Zhou) and depicted in FIGS. 1A-1C labeled Prior Art. As depicted, an electric vehicle drive system 10 for an electric vehicle is disclosed. The drive system comprises a DC power source or battery 11 coupled with two contactor switches 12 and 13 configured and arranged to couple the battery to a positive and negative bus (22, 23) respectively, upon which a number of inverters 17 and a linking capacitor 16 are arranged such that the switches of the inverter may be switched as needed to drive motor 18. Each of the switching devices in inverter 17 includes an IGBT. The inverter 17 may comprise at least 6 switched MOSFETs. A controller 20 is configured and arranged to control a discharge circuit 25 of the link capacitor 16. The discharge circuit 25 includes a discharge resistor 26 arranged in series with a discharge switch (27, FIGS. 1A and 31, FIG. 1B) which in turn has a control terminal for selectably turning the discharge switch on and off via a disable circuit 28 in response to a disable command from the controller 20. The function of the disable circuit 28 is to perform a logical inversion of the disable command signal wherein when the command signal has a high logic level, an output of the disable circuit 28 connected to the control terminal has a low voltage level so that switch 27 is turned off and capacitor 16 is not discharged. When the command signal has a low logic level, the output of the disable circuit 28 is automatically pulled up to a voltage sufficient to turn on the discharge switch 27 and capacitor 16 discharges. Here, Zhou relies upon controller 20 to affect the capacitor discharge. A timing circuit 33 may be added so as to fix the duration of the discharge to be just long enough to discharge the energy stored in the link capacitor (see FIG. 1B). In another embodiment depicted in Zhou FIG. 4, the discharge switch 31 may comprise an enhancement mode MOSFET (a type of MOSFET that requires application of a voltage to its gate terminal to induce a conductive channel between source and drain). By the aforementioned arrangements and as depicted in FIG. 1C by way of graph 40, an HVDC capacitor at full power (see Y axis labeled Watts) is fully discharged within two seconds (see X axis labeled T for time).

Although a number of different HVDC capacitor discharging systems and methods are known in the art, each relies, at least to some degree, on the inverter control unit, a gate driver and/or power supply. Additionally, such discharge circuits are typically not fast or efficient enough to safely dissipate the energy stored within the HVDC capacitors within the respective emergency critical time frame. A need therefore exists in the art for the safe and effective discharge of an HVDC capacitor within a matter of milliseconds and/or certainly less than one second. Such systems should further be independent of the control unit, gate driver and power supply so as to function (discharge the HVDC capacitor) under in an emergency situation and the like.

A common feature in circuits is the operational amplifier (op-amp) which is an electronic component widely used in circuits. It is a high-gain voltage amplifier with differential inputs (inverting (−) and non-inverting (+)) and usually a single output. Its primary function is to amplify differences in voltage between the two inputs. Op-amps are versatile and can be configured to perform mathematical operations, signal conditioning, filtering, and many other functions.

### BRIEF SUMMARY OF THE INVENTION

It is an object of the present invention to provide a drive system and method for the controlled, rapid and safe energy discharge of a HVDC link capacitor within the power electronics of an electrically power vehicle. The present system and method include an active discharge circuit that is activated or deactivated without the active participation of a control unit. In other aspects of the present invention the activation or deactivate is affected without an additional gate driver or a dedicated power supply. Accordingly, the present invention provides a system and method that functions independent of a control unit, gate drive or power supply, all of which may fail due to vehicle duress. As such situations still necessitate controlled discharge of the link capacitor to safe levels, the present system and methods aforementioned independence results in enhanced safety over prior art systems that are not so independent.

In an aspect of the present invent, the instant drive system and method provide a constant current discharge of the link capacitor such that the link capacitor may be discharged from at least 800 volts to 60 volts or less within 250 milliseconds. Such speed offers obvious advantages over prior art systems that may require 2 seconds or more for effective discharging.

In another aspect of the present invention, the active discharge circuit includes a MOSFET in series with a load resistor arranged coupled to the positive DC bus and a series or shunt resistor arranged coupled to the negative DC bus. The MOSFET may be activated or deactivated by an amplified signal from turn-on logic arranged in communication with the MOSFET. The MOSFET may further be in negative feedback with the DC bus in which the MOSFET is arranged. The MOSFET, when activated, operates in its linear mode.

In another aspect of the present invention, three MOSFETs with respective resistors may be arranged in parallel so as to form the discharge circuit. This aspect finds application and implementation within an automobile such as an electric and hybrid driven vehicles.

### BRIEF DESCRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

In the following, an advantageous embodiment of the invention is explained with reference to the accompanying figures, wherein:

FIGS. 1A and 1B depict prior art drive systems;

FIG. 1C depicts a prior art timing graph;

FIG. 2 depicts a drive system according to a first aspect of the present invention;

FIG. 3 depicts a drive system according to a second aspect of the present invention;

FIGS. 4 and 5 depict timing graphs; and

FIG. 6 depicts a method according to the present invention.

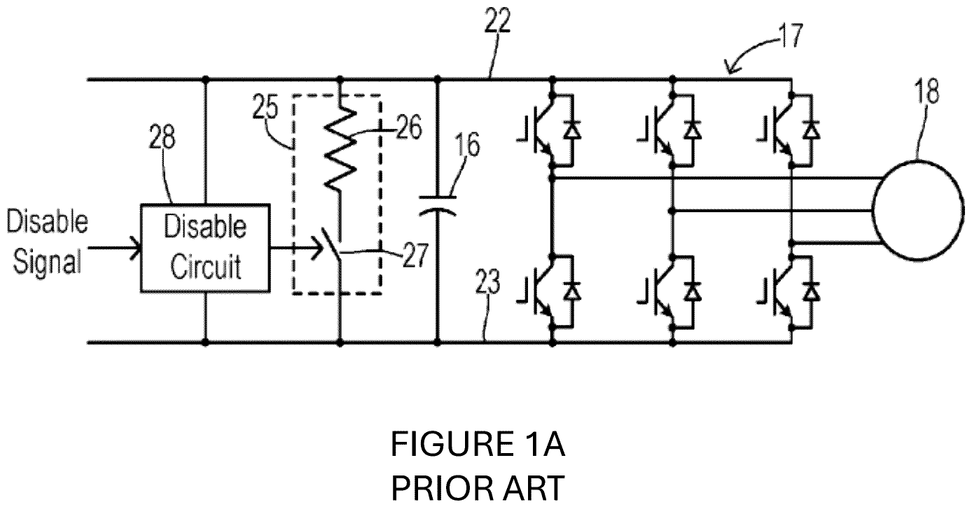

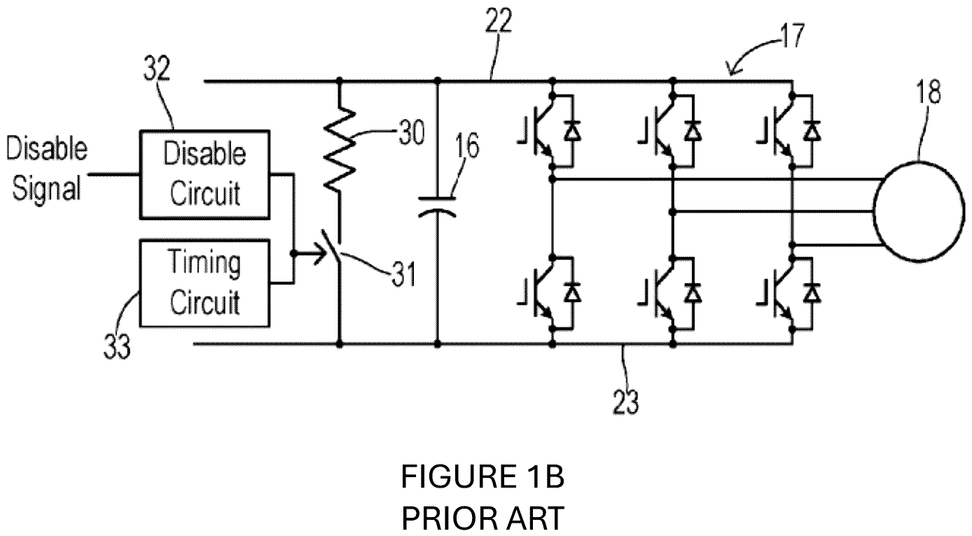

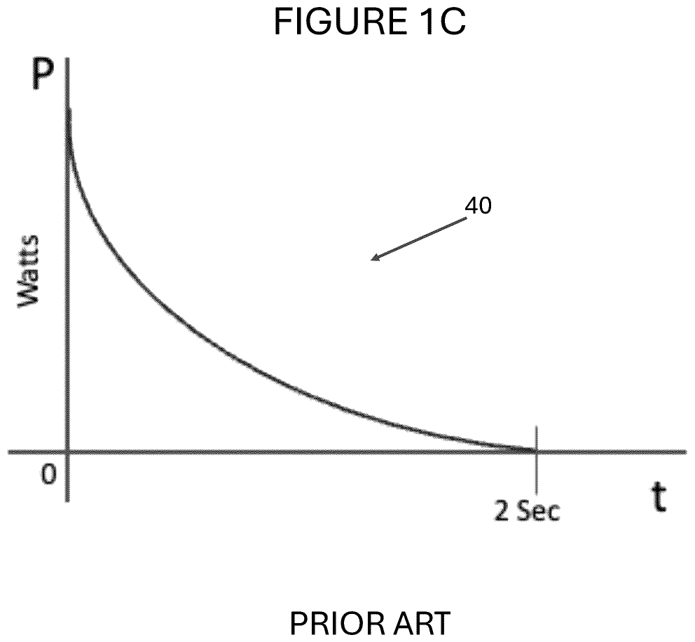

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C” should be understood as including only one of A, only one of B, only one of C, or any combination of A, B, and C.

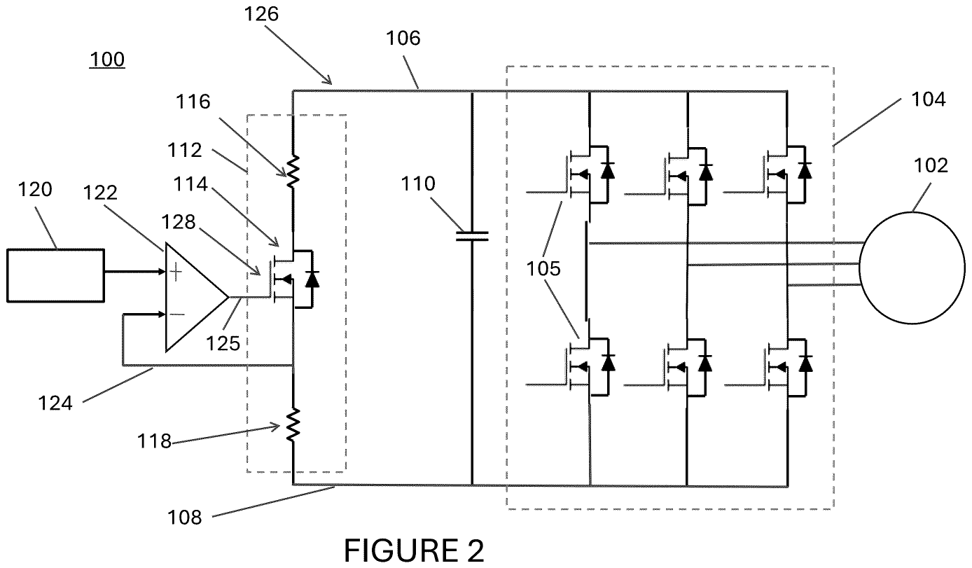

FIG. 2 depicts a drive system 100 for powering a motor 102 via an inverter 104 which comprises six switched MOSFETs 105, though the number may vary as understood by the skilled person. The drive system 100 includes a DC link capacitor 110 coupled to a positive bus 106 and negative bus 108. Arranged in parallel with the link capacitor 110 is an active discharge circuit 112 configured and arranged to rapidly, safely and continuously discharge the link capacitor. The discharge circuit 112 comprises MOSFET 114 arranged in series with a load resistor 116 and shunt/series resistor 118, the aforementioned three elements coupled to the positive and negative busses (106, 108). In an aspect of the present invention, the MOSFET is intended to act as a precise switch reactive in response to a single input based upon a single consideration. As depicted, turn-on logic 120 is coupled to the MOSFET 114 via op-amp 122 to which a negative feedback 124 with the power bus 126 is further connected.

Turn-on logic refers to the specific conditions and circuitry used to enable or activate a device, component, or system. It is particularly significant in electronic systems, especially in power electronics and semiconductor devices, where it dictates how and when components like MOSFETs, transistors, logic gates, or systems transition from an off-state to an on-state. As applied herein, the turn-on logic is assigned a particular reference voltage related to the link capacitor, namely, a threshold the exceeding of which triggers rapid capacitor discharge. For example, an application of the present invention may require rapid discharge when the link capacitor's voltage exceeds 800 volts as may arise for example from excessive voltage received from the motor. Alternatively, a particular application may require discharge at lower voltages. The turn-on logic voltage may be set in advance by the skilled person.

The op-amp 122 is used as a voltage comparator, functioning to compare the voltage received from the turn-on logic at its non-inverting (+) terminals with voltage received from the negative feedback 124 at its inverting terminal (−). Shunt resistor 118 is placed in series with the link capacitor 110 and inverting terminal (−) such that current flowing through the resistor is converted into a proportional voltage (as per Ohm's Law) the proportional voltage then being fed via the negative feedback 124 into the inverting terminal (−) of the op-amp 122. The op-amp then compares the two received voltages and if the voltage received via the negative feedback 124 exceeds the reference voltage from the turn-on logic, the op-amp will generate an output 125 to the MOSFET gate. Accordingly, the negative feedback is used to adjust the gate voltage of the MOSFET based upon the current sensed from the link capacitor. The MOSFET is made to operate in the linear active mode. As the negative feedback approaches the reference voltage, differences between the two. A threshold difference may be set at the op-amp such that when the aforementioned difference falls within the threshold difference, the op-amp generates a deactivate signal which is then set to the MOSFET thereby terminating the connection between link capacitor and load resistor.

The MOSFET 114 is then run in linear mode, namely, the MOSFET is utilized to maintain a constant current discharge. The MOSFET operates in the linear region when the drain-source voltage (V_{DS}) is small and the device acts as a variable resistor. In this mode, the drain current (I_{D}) is directly proportional to (V_{DS}) for a fixed gate-source voltage (V_{GS}). To achieve a constant current, the gate-source voltage (V_{GS}) is dynamically adjusted to counter variations in load or supply voltage. A feedback control system is often used to sense the actual current and modulate (V_{GS}), ensuring that (I_{D}) remains constant. To maintain a constant current discharge, the circuit leverages the following. For current sensing a current sense resistor (placed in series with the load) or a current sensor IC is used to measure the instantaneous current. The sensed current is fed back to a control circuit (such as an op-amp in a feedback configuration). The control circuit compares the sensed current to a reference value (desired constant current) and adjusts (V_{GS}) accordingly. As the load or supply voltage changes, the MOSFET's resistance is dynamically altered by varying (V_{GS}), maintaining the desired current. In linear mode, the MOSFET dissipates significant power as heat because P=(V_{DS})×(I_{D})=(V_{DS})×(I_{D}). Proper heat sinking and thermal design are critical to ensure reliable operation.

By this arrangement, the link capacitor begins to discharge thereby reducing the current directed to shunt resistor 118, negative feedback loop 124 and op-amp 122 where the incoming voltage is compared with the reference voltage so as to determine whether to continue adjusting the MOSFET gate and continuing to switch the shunt and load resistors. When the desired current/voltage is sensed at the op-amp, the MOSFET is made to switch again thereby disconnecting the two resistors and effectively halting the discharge of the link capacitor. Accordingly, a mechanism is provided to affect a direct reaction directly in response to that which is sensed from the link capacitor thereby ensuring that upon the occurrence of a triggering event—namely, an exceeding the voltage set in the turn-on logic—the MOSFET reacts. Such is performed without the inclusion or support of, namely independent of, a microcontroller unit or other such control unit. Additionally, such is performed independent of power supplies and circuitry including sensing circuits, timing circuits and the like. Here, an aspect of the present system is that it operates in response to a single leg making for a simplified arrangement offering advantageous manufacturing and implementation over the state of the art. As such, for example, in the event of a vehicular crash or other such duress/emergency situation, while all switches stop, energy remains in the motor and the capacitor will accordingly continue to be charged. Control units, other such circuits and the like, will no longer function. However, given the independence of the present system and its reliance upon precision current control and MOSFET activation, the link capacitor is rapidly and safely discharged.

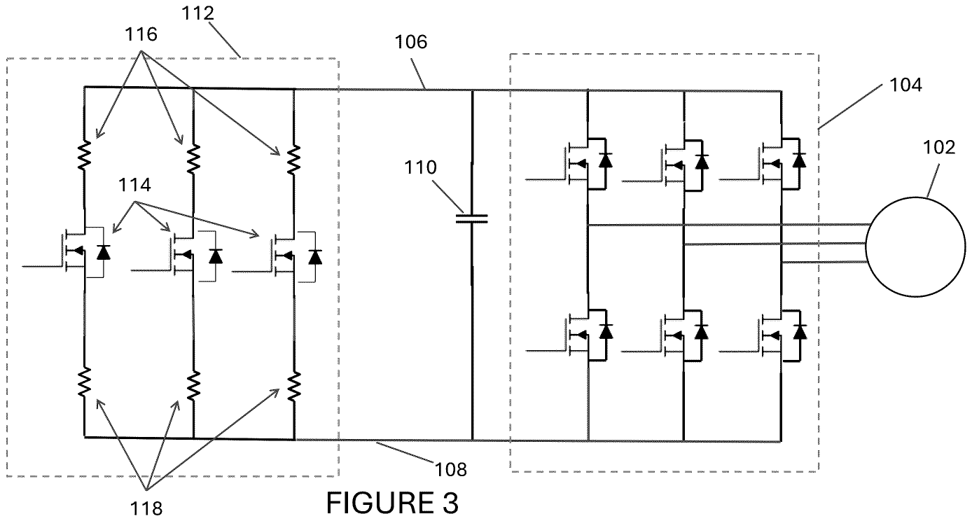

FIG. 3 depicts the present system with redundancies built in, namely, the discharge circuit 112 now comprises three MOSFETs 114 arranged with three sets of load and shunt resistors (116, 118) in parallel between positive and negative buses 106 and 108. The number of redundancies is a matter of design choice understood by the skilled person to offer various advantages including faster discharge time and compliance with legal requirements for implementation into various vehicles.

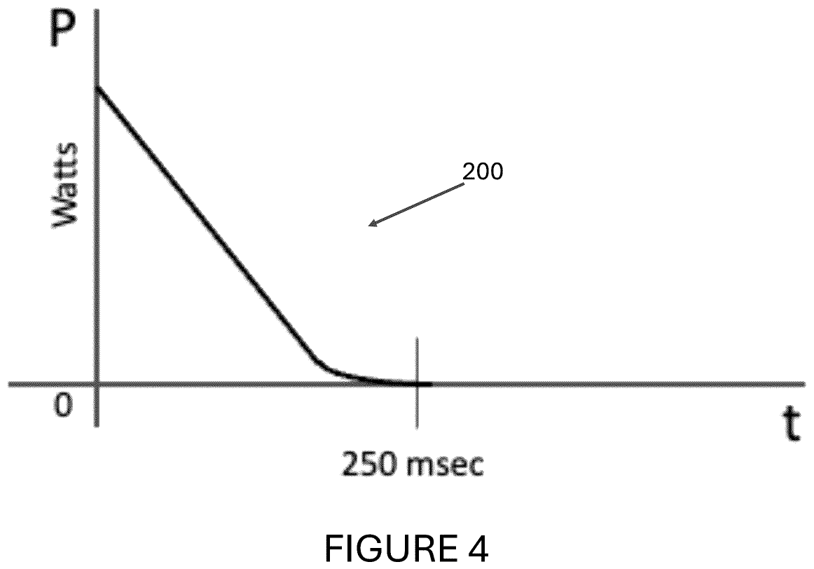

FIG. 4 depicts a power P discharge time 200 made possible by the present system, such being measured in terms of watts along the y-axis and time t along the x-axis. As depicted, the discharge is largely linear until making a soft landing at 250 milliseconds.

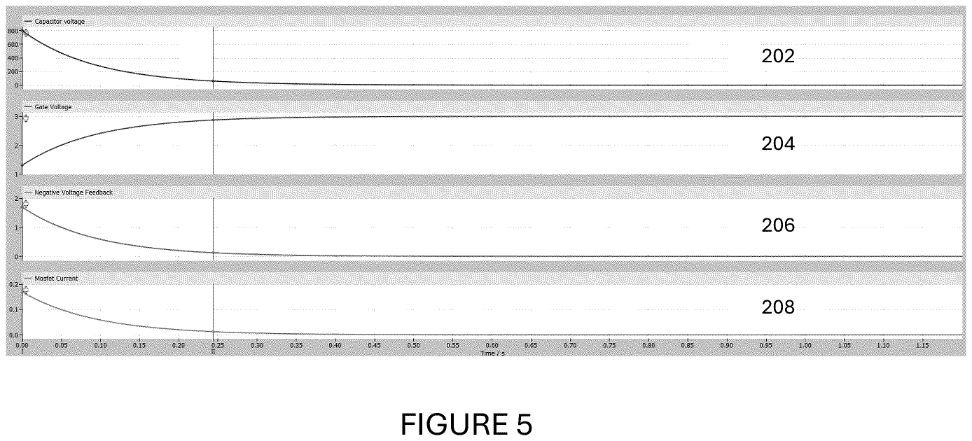

FIG. 5 depicts a simulation of the impact on the discharging capacitor in terms of its voltage 202, gate voltage 204, negative feedback voltage 206 and MOSFET current 208, as a product of time is depicted. As depicted at just under 0.25 seconds, each of the aforementioned arrive at safe levels thereby indicating a discharged link capacitor.

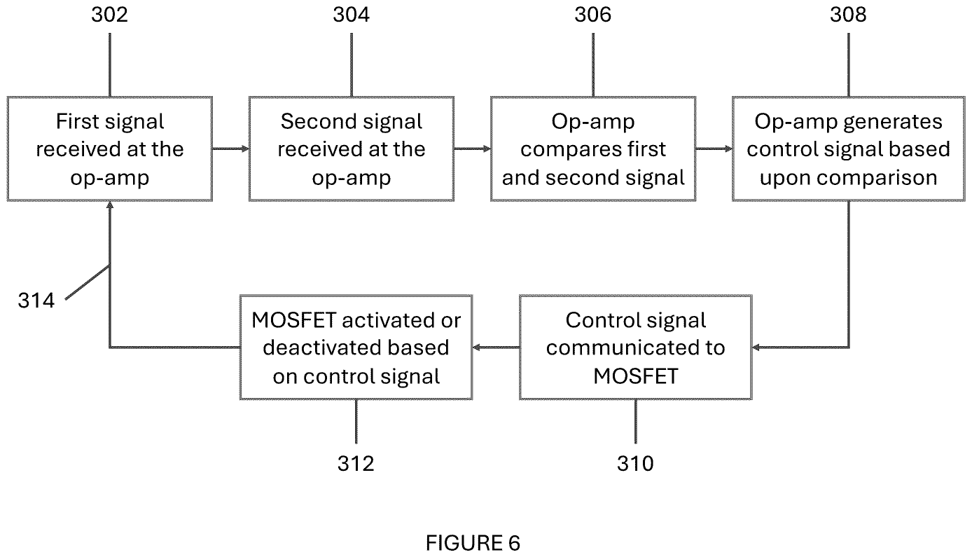

A method of discharging a link capacitor according to the present system will now be described with general reference to FIG. 6. Execution of the method may be made upon the instant system. Accordingly, the method will be described within the context of the present system. In step 302, a first signal is received at the op-amp. The first signal may originate via the aforementioned negative feedback loop, such signal being at least representative of the voltage or capacitance across the link capacitor possibly in need or for selection of discharging. In step 304, a second signal is received at the op-amp. While depicted in successive steps, it is within the scope of the present invention that the first signal may be received at the op-amp after the second signal. The second signal may be a reference signal originating from a pre-programmed turn-on logic and the like. In step 306, the op-amp compares the first and second signals and in response thereto generates a control signal (step 308) which may then be communicated to the MOSFET (step 310) and used to activate or deactivate the MOSFET (312) preferably operating in its linear mode. When activated, the MOSFET switches the link capacitor to the load resistor such that the latter discharges the former. The method automatic repeats (see arrow 314). As the link capacitor discharges, the second signal becomes weaker and eventually meets or substantially matches the first or reference signal such that no appreciable difference exists thereby causing the op-amp to generate a control signal which deactivates the MOSFET thereby terminating the connection between link capacitor and load resistor thus ending the link capacitor's discharging. Essential to the method is that it operates via a single leg, namely and preferably, the single inputted control signal generated by a single action, here being the comparison of two input signals. The single leg affords the present method independence from a control unit, timing circuit and/or power supply thereby increasing the present system's versatility and utility.

Since the devices and methods described in detail above are examples of embodiments, they can be modified to a wide extent by a person skilled in the art without departing from the scope of the invention. In particular, the mechanical arrangements and the proportions of the individual elements to one another are merely exemplary.

1. A drive system for an electric vehicle, comprising:
a DC link capacitor configured and arranged to couple with a positive and negative DC bus;
an active discharge circuit connected across the link capacitor, the active discharge circuit comprising at least two resistors in series with at least one MOSFET configured to operate in its linear region so as to selectively maintain a constant current discharge of the link capacitor;
an operational amplifier in connection with turn on logic and a negative feedback loop arranged in series with one of the at least two resistors and configured to provide the operational amplifier with a first voltage indicative of a voltage level within the DC link capacitor, the turn on logic configured and arranged to provide the operational amplifier with a reference voltage, and the operational amplifier configured and arranged to make a comparison between the reference voltage and the first voltage, generate a control signal in response to the comparison and direct the control signal to the MOSFET; and
wherein the MOSFET is driven by the control signal generated from the operational amplifier.

2. The drive system according to claim 1, wherein the drive system operates without a control unit, timing circuit and/or power supply configured and arranged to activate or deactivate the MOSFET.

3. The drive system according to claim 1, wherein the active discharge circuit comprises at least three MOSFETs arranged in parallel, each of the three MOSFETs arranged in series with at least two resistors.

4. The drive system according to claim 3, wherein at least one of the at least two resistors is a load resistor and at least one of the at least two resistors is a shunt resistor.

5. The drive system according to claim 4, wherein:
shunt resistor is arranged between the DC link capacitor and the negative feedback loop; and
the load resistor is arranged between the MOSFET and the positive bus.

6. The drive system according to claim 1, wherein the constant current discharge discharges the link capacitor within 250 millisecond.

7. The drive system according to claim 1, comprising a single leg.

8. The drive system according to claim 1, further comprising an inverter arranged in series with the link capacitor and an electric motor arranged to be driving be the drive system.

9. The drive system according to claim 8, wherein the inverter comprises at least six switched MOSFETs.

10. A method for discharging a link capacitor in a drive system, comprising the steps of:
receiving a first signal at an operational amplifier, the first signal indicative of a voltage or current across a link capacitor;
receiving a second signal at the operational amplifier, the second signal comprising a reference signal;
causing the operational amplifier to form a comparison between the first signal and the second signal
generating a control signal at the operational amplifier based upon the comparison;
communicating the control signal to a switched MOSFET;
causing the MOSFET to activate or deactivate in response to the control signal such that when activated the MOSFET directs a voltage originating from the link capacitor across a first resistor thereby discharging the link capacitor and when deactivated the MOSFET prevents a voltage originating from the link capacitor from reaching the first resistor; and
wherein the MOSFET is driven by a single leg.

11. The method according to claim 10, wherein the drive system wherein the drive system operates without a control unit, timing circuit and/or power supply configured and arranged to activate or deactivate the MOSFET.

12. The method according to claim 11, further comprising the steps of:
arranging a negative feedback look in a circuit between the link capacitor and the operational amplifier; and
arranging a second resistor in the circuit between the link capacitor and the negative feedback loop, wherein the circuit is configured and arranged to carry the first signal.

13. The method according to claim 12, wherein the first resistor is a shunt resistor and the second resistor is a load resistor.

14. The method according to claim 13, further comprising the step of operating the MOSFET in linear mode.

15. The method according to claim 14, further comprising at least three MOSFETS each of the three MOSFETs arranged in series with at least two resistors.

16. The method according to claim 10, wherein the link capacitor is discharged within 250 millisecond.
